(19) United States
(12) Patent Application Publication
(10) Pub. No.: US 2014/0356578 A1
(43) Pub. Date: Dec. 4, 2014

(54) Method for Structuring a Surface of a Workpiece

(71) Applicant: EADS Deutschland GmbH, Ottobrunn (DE)

(72) Inventors: Erhard Brandl, Eitensheim (DE); Ante Kurtovic, Paderborn (DE); Tobias Mertens, Putzbrunn (DE); Dominik Raps, Muenchen (DE)

(21) Appl. No.: 14/366,583

(22) PCT Filed: Dec. 20, 2012
(86) PCT No.: PCT/DE2012/001215

§ 371 Date: Jun. 18, 2014

(30) Foreign Application Priority Data
Dec. 20, 2011 (DE) 10 2011 121 546.1

(51) Int. Cl. B23K 26/00; B23K 26/12; B23K 26/08

(52) U.S. Cl. CPC B23K 26/0078; B23K 26/0084; B23K 26/0807; B23K 26/122
USPC 428/141; 428/687; 219/72; 219/121.8

(57) ABSTRACT

A method for producing a metal or metal alloy surface or metal oxide layer or metal alloy oxide layer on the surface of a workpiece having surface structures with dimensions in the sub-micrometer range, involves scanning the entire surface of the metal or of the metal alloy or of the metal or metal alloy oxide layer on the metal or the metal alloy on which the structures are to be produced and which are accessible to laser radiation one or more times by a pulsed laser beam in such a way that adjacent flecks of light of the laser beam adjoin one another without gaps or overlap one another and a specific region of a predetermined relation between method parameters is satisfied.

### CROSS-REFERENCE TO RELATED APPLICATIONS

This application related to PCT International Application PCT/DE2012/001214, filed, Dec. 20, 2012, a national stage of which is U.S. application Ser. No. ______ (Attorney Docket No. 110073.66621US).

### FIELD OF THE INVENTION

Exemplary embodiments of the invention relate to a method for structuring a surface of a workpiece, wherein surface structures with dimensions in the sub-micrometer range are produced, as well as workpieces with surfaces which can be produced thereby.

### BACKGROUND OF THE INVENTION

The wettability with and adhesion of liquid, semi-solid and solid substances on metals and metal oxides is highly dependent upon the surface quality. The wettability is very significant in the treatment with or application and adhesion of materials such as for example bonding adhesive, paint, solder, sealant or also biological tissue. Degreasing and other cleaning as well as etching increase the wettability and adhesion to a certain degree. These characteristics are significantly improved with increasing roughness of the surface, i.e. a larger and more structured surface and resulting increased chemical/mechanical anchoring of materials to be applied. A satisfactory roughness of the surface can also be achieved, for example, by anodizing processes, but the methods are technically relatively costly and involve some chemicals which are hazardous to health. A further disadvantage is that the anodizing processes must be tailored to a specific metal. Moreover, anodizing processes consist of a plurality of individual process steps such as a prior cleaning and etching before the actual anodizing process.

European patent document EP 0 914 395 B1 describes a method for treatment of an uncleaned metal surface, the method comprising the treatment of the surface with an organosilane and exposure of the surface to a laser.

Exemplary embodiments of the invention provide as simple method as possible without the need for the use of chemicals for producing a good roughness on a metal (alloy) surface.

### BRIEF SUMMARY OF THE INVENTION

The invention relates to a method for structuring a surface of a workpiece, comprising a metal or a metal alloy or a metal oxide layer or metal alloy oxide layer present on a metal or metal alloy surface, wherein surface structures with dimensions in the sub-micrometer range are produced, wherein the entire surface of the metal or of the metal alloy or the metal or metal alloy oxide layer on the metal or the metal alloy which is accessible to laser radiation, and on which the structures are to be produced, is scanned one or more times by a pulsed laser beam in such a way that adjacent flecks of light of the laser beam adjoin one another without gaps or overlap one another, wherein the following conditions are met:

approximately 0.07≦ε≦approximately 2300
with

$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$

wherein:
Pₚ: peak pulse power of the outgoing laser radiation [kW]
Pₘ: average power of the outgoing laser beam [kW]
t: pulse length of the laser pulses [ns], wherein t is approximately 0.1 ns to approximately 2000 ns,
f: repetition rate of the laser pulses [kHz]
v: scanning speed on the workpiece surface [mm/s]
d: diameter of the laser beam on the workpiece [μm]
α: absorption of the laser radiation of the irradiated material [%] under normal conditions
λ: wavelength of the laser radiation [nm], wherein λ=approximately 100 nm to approximately 11000 nm
T_{V}: boiling point of the material [K] at normal pressure
cₚ: specific thermal capacity [J/kgK] under normal conditions
κ: specific thermal conductivity [W/mK] under normal conditions
wherein the atmosphere in which the method is carried out is a vacuum, ambient atmosphere or an inert gas or gas mixture.

The pressure of the atmosphere in which the method is carried out is generally in the range from approximately 0 bars to approximately 15 bars and the temperature of the atmosphere is outside of laser beam generally in the range from approximately −50° C. to approximately 350° C.

The invention further relates to a workpiece which comprises a surface of a metal or a metal alloy or a metal oxide layer or metal alloy oxide layer on the surface of the metal or the metal alloy, wherein the surface has a structure which can be produced by the aforementioned method.

### BRIEF DESCRIPTION OF THE DRAWINGS

FIG. 1 shows an untreated surface of rolled metal sheet made of Ti-6Al-4V.

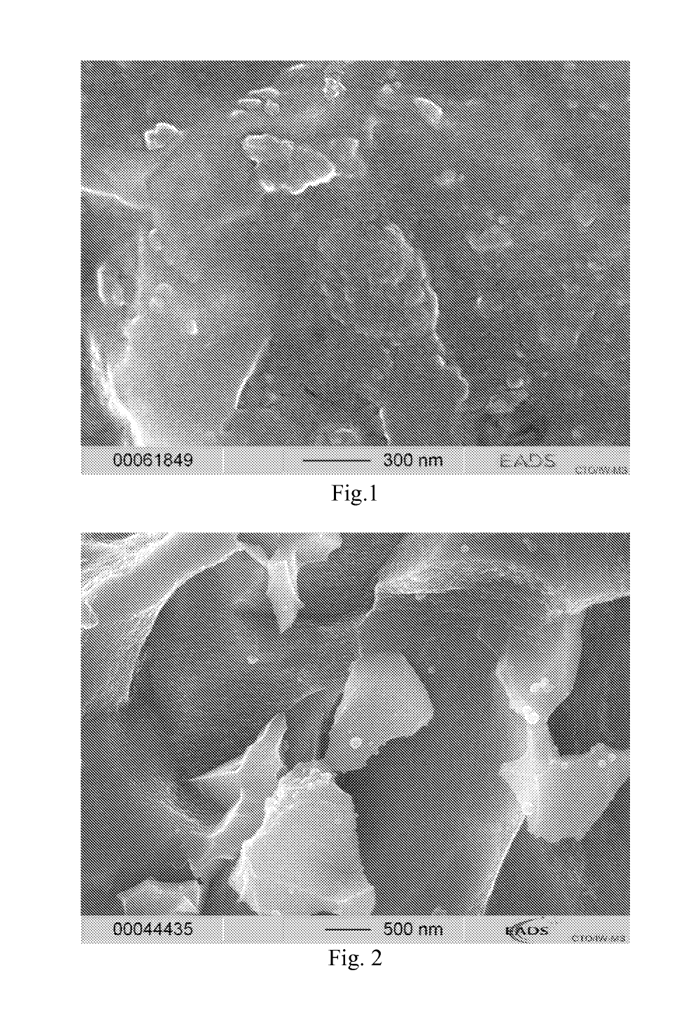

FIG. 2 shows an etched surface of etched metal sheet made of Ti-6Al-4V.

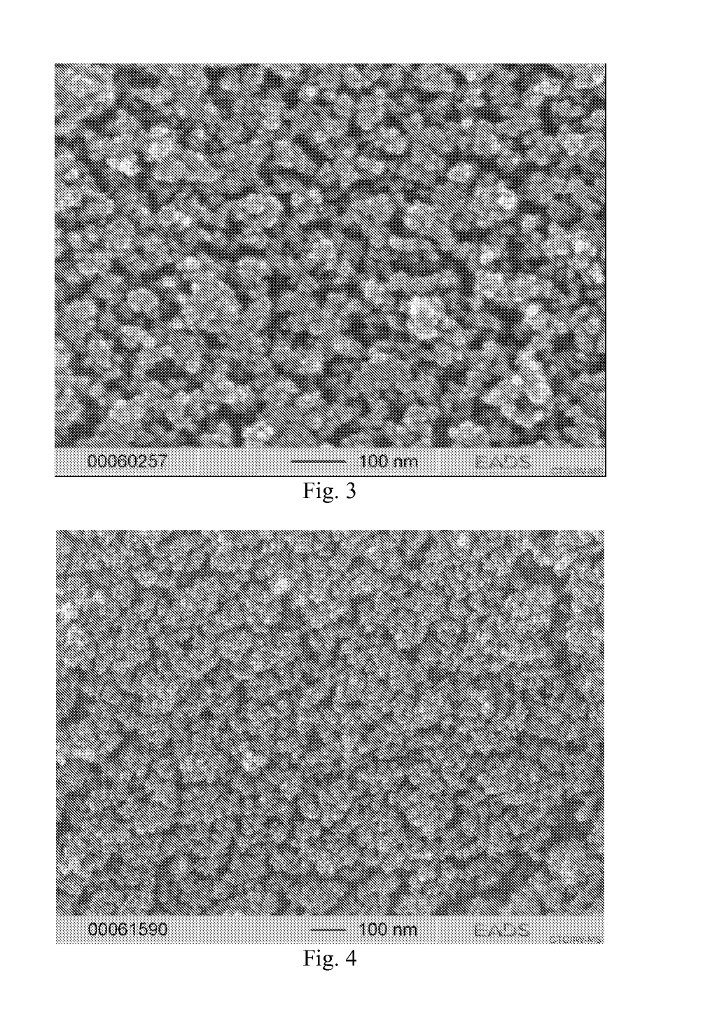

FIGS. 3 to 8 show the surfaces of metal sheets made of different materials and treated according to Examples 1 to 5 according to the invention.

FIGS. 9 to 11 show the surfaces of metal sheets made of Ti-6Al-4V and treated according to Examples 6 to 8 according to the invention. The upper two illustrations show the surfaces at different resolution, the lower both illustrations show the corresponding break edges.

FIG. 12 shows the surface of a comparative example, wherein the parameter ε is outside the range according to the invention.

FIG. 13 shows a schematic representation of a wedge test.

FIG. 14 shows the results of wedge tests of Examples 6 to 8 by comparison with surfaces treated according to the prior art.

### DETAILED DESCRIPTION

As mentioned in the introduction, the roughening or structuring in the sub-micrometer range of surfaces is essential for a good adhesion of bonding adhesives, varnishes and other coatings.

Surprisingly it has now been found that merely by irradiation once or several times with a pulsed laser under the conditions described herein it is possible to produce sub-microstructured (or nanostructured) metal and metal alloy surfaces as well as, if the surfaces are passivated by an oxide layer, sub-microstructured (or nanostructured) metal (alloy) oxide surfaces, which ensure an excellent adhesion of bonding adhesives, varnishes, solder, sealants and/or the like as well as biological tissue or other coatings. If two metals or one metal with another material are connected to one another by a rolling process at room temperature (e.g. cold rolling of gold) or at high temperatures (e.g. accumulative roll bonding, laser roll bonding) or by a microforging process (e.g. cold gas spraying), the adhesion of these joined materials can be increased if nanostructures have been produced on at least one side according to the invention.

Depending upon the embodiment the surfaces produced can, in general, have open-pored, split and/or fractal-like nanostructures, such as open-pored peak and trough structures, open-pored undercut structures and cauliflower-like or bulbous structures. At least approximately 80%, preferably at least approximately 90%, more preferably at least approximately 95% raised portions have a size<1 μm, which is, for example in the range from approximately 10 nm to approximately 200 nm. At least approximately 80%, preferably at least approximately 90%, more preferably at least approximately 95% of the interstices also have widths<approximately 1 μm, e.g. approximately 10 nm to approximately 50 nm. However, the length of the “troughs” in peak and trough structures is frequently more than approximately 1 μm.

As a rule such nanostructures cover at least approximately 90% of the surface calculated as a plane, preferably at least approximately 95%. With optimally tailored process parameters (in particular repetition rate, scanning speed and focus diameter) the nanostructure can even cover approximately 100% of the surface cover calculated as a plane.

The scanning of the surface with the laser beam can be carried out once or several times one after the other. Under some circumstances an even finer structure can be produced by scanning several times.

Usually the metal or metal oxide surface is not pretreated or cleaned before the scanning with the laser beam, although this is not precluded; for example the surface can be cleaned or etched with a solvent. Preferably, however, unlike the process described in European patent document EP 0 914 395 B1, before the scanning the surface is not treated with an adhesion promoter, such as for example a silane adhesion promoter, a titanate, such as titanium tetraisopropylate or titanium acetylacetonate, a zirconate, such as zirconium tetrabutylate, a zirconium aluminate, a thiazole, a triazole, such as 1H-benzotriazole, a phosphonate or a sulphonate, in order to increase the adhesive strength on a material to be connected to the surface or on a material to be connected or applied to the surface. Also, after the scanning, frequently no adhesion promoter is applied in order to increase the adhesive strength, before the surface is connected to another surface and/or a coating, such as a bonding adhesive, varnish, solder, sealant and/or the like or biological tissue or and/or some other coating, which may be for example a protective coating, dirt-repellent or non-stick coating or other functional coating, is applied and/or made to adhere thereto.

The metal or metal alloy optionally coated with an oxide layer, for which the method according to the invention can be carried out, is not subject to any limitations. It may be selected for example from iron, aluminum, tantalum, copper, nickel or titanium or an alloy thereof, for example Ti-6Al-4V, pure titanium, Mg-4Al-1Zn, Ta-10W, Cu—OF, CuZn37, Al 2024 (Al-4.4Cu-1.5Mg-0.6Mn), V2A steel (X5CrNi18-10) and Inconel 718® (high temperature resistant nickel alloy with Ni-19Cr-18Fe-5Nb-3Mo-0.05C (material number 2.4668)).

The boiling point at normal pressure, the specific thermal capacity cₚ under normal conditions, the specific thermal conductivity κ under normal conditions and the absorption of the laser radiation of the irradiated material α under normal conditions, which are to be inserted into the above-mentioned expression for ε, are accordingly simply material properties of the treated metal or the treated metal alloy. In the case of metals or metal alloys covered with an oxide layer the data of the underlying metal or metal alloy are used.

It should also be mentioned that naturally it is only possible to treat those surface regions which can be reached by a laser light. Regions which lie completely “in the shadow” (e.g. in the case of undercut geometries) cannot be structured in the manner described here.

It is believed—but without being tied to one theory—that the mechanism of the surface structuring includes a partial vaporization of the metal on the surface as well as a resolidification of molten material. The vaporized quantity of the metal as well as the region in which the material melts should depend upon the intensity of the light at each individual location on the surface. With an oxide coating on the metal or the metal alloy it is conceivable that under the laser light first of all oxygen evaporates from the surface, and it would then rejoin the surface upon cooling. Also the mere melting and resolidification of the metal or metal oxide could lead to a dendritic, open-pored, split and/or fractal-like structure.

The values of ε that must result from the parameters of the equation set out above, in order to produce the surface structuring sought according to the invention, are preferably with approximately 0.07≦ε≦approximately 2000, more preferably with approximately 0.07≦ε≦approximately 1500.

Preferred parameters of the method according to the invention are set out below. It must be emphasized that all parameters can be varied independently of one another.

The pulse length of the laser pulses t is preferably approximately 0.1 ns to approximately 300 ns, more preferably approximately 5 ns to approximately 200 ns.

The peak pulse power of the outgoing laser radiation Pₚ is preferably approximately 1 kW to approximately 1800 kW, more preferably approximately 3 kW to approximately 650 kW.

The average power of the outgoing laser radiation Pₘ is preferably approximately 5 W to approximately 28000 W, more preferably approximately 20 W to approximately 9500 W.

The repetition rate of the laser pulses f is preferably approximately 10 kHz to approximately 3000 kHz, more preferably approximately 10 kHz to approximately 950 kHz.

The scanning speed on the workpiece surface v is preferably approximately 30 mm/s to approximately 19000 mm/s, more preferably approximately 200 mm/s to approximately 9000 mm/s.

The diameter of the laser beam on the workpiece d is preferably approximately 20 μm to approximately 4500 μm, more preferably approximately 50 μm to approximately 3500 μm.

As mentioned above, the laser wavelength λ may be approximately 100 nm to approximately 11000 nm. Lasers that may be used are, for example, solid state lasers, such as for example Nd:YAG (λ=1064 nm or 533 nm or 266 nm), Nd:YVO₄ (λ=1064 nm), diode lasers with for example λ=808 nm, gas lasers, such as for example excimer lasers, with for example KrF (λ=248 nm) or H₂ (λ=123 nm or 116 nm) or a CO₂ laser (10600 nm).

The operating atmosphere may be, as mentioned above, a vacuum, ambient atmosphere or a so-called inert gas, such as a noble gas, for example argon, helium or neon, or in many cases also nitrogen or CO₂, or a mixture of inert gases, wherein the pressure is generally in the region of approximately 0 bars to approximately 15 bars and the temperature is in the range from approximately −50° C. to approximately 350° C. The atmosphere is selected so that in the case of given metal, metal alloy or oxide coating thereon it is inert under the operating conditions of pressure and temperature, that is to say that no reaction occurs with the metal, the metal alloy or an oxide coating thereon. In many cases for example this may involve an ambient atmosphere at ambient pressure and ambient temperature, which is preferred if the given surface allows this. The person skilled in the art knows the conditions under which a given surface is inert and/or can find this out by suitable analysis methods, such as X-ray photoelectron spectroscopy (XPS), EDX (energy dispersive X-ray analysis), FTIR spectroscopy, time of flight secondary ion mass spectrometry (TOF-SIMS), EELS (electron energy loss spectroscopy), HAADF (high angle annular dark field) or NIR (near infrared spectroscopy).

In embodiments of the method according to the invention, after the structuring of the surface the surface is joined or without bonding adhesive to a surface of a second workpiece to form a composite workpiece joined together or is provided with a coating or is chemically modified.

The surfaces produced according to the invention ensure an excellent adhesion of bonding adhesives, varnishes and other coatings. If nanostructures have been produced according to the invention on at least one metal or metal oxide, it is possible for two metals, one metal and one metal oxide or two metal oxides or one metal or metal oxide with another material to be connected to one another with satisfactory adhesion to form a composite workpiece by simple joining under high pressure, such as by a rolling process at room temperature (e.g. cold rolling of gold) or at high temperatures (e.g. accumulative roll bonding, laser roll bonding) or by a microforging process (e.g. cold gas spraying). If necessary, however, any bonding adhesive known for this purpose to the person skilled in the art can be used in order to assist the connection.

The coating may be any coating for metal and metal oxides and it can be applied in any suitable way.

As examples of such coatings mention may be made of solders, coatings applied by thermal and non-thermal spraying, varnishes, other coatings with glass-like materials, ceramics and inorganic-organic or organic materials, which are optionally directly produced on the surface produced according to the invention, and also with biochemical and biological materials, for example cells and/or body tissue.

As specific examples of varnishes and similar coatings mention may be made of polyurethane, acrylic, vinyl and epoxy-based coatings as well as zinc-rich inorganic and inorganic-organic coatings. Further examples are silane coatings, for example silanes (obtainable for example under the trade name Oxsilan®) which are to be polymerized to siloxanes, which can be applied in particular to structured surfaces according to the invention containing oxygen atoms.

If an adhesion promoter coating is used, silane adhesion promoters can be applied inter alia to the surface. An example of such an adhesion promoter that can be applied to oxygen-free structured metal surfaces is an aqueous solution (sol) of zirconium salts activated by organosilicon compounds, which after the evaporation of the water supplies an adhesion-promoting gel (obtainable for example under the trade name SOCOGEL® or Alodine® SG 8800).

As mentioned above, the structured surfaces can also be modified chemically in any way known to the person skilled in the art, for example by chemical transformation to produce conversion layers which have inter alia an anti-corrosive effect. Here, reference may be made to, for example, conventional chromating with chromium (VI), chromating with reagents on the basis of chromium (III) (for example SurTec® 650), chromium-free zinc phosphating or the application of chromium-free zirconium, titanium or vanadium conversion layers.

The following examples explain the invention, without limiting it.

### EXAMPLES

### Example 1

A rolled metal sheet made of the alloy Ti-6Al-4V was scanned without any pre-treatment once with a diode-pumped Nd:YVO₄ (neodymium-pumped yttrium orthovanadate) laser (wavelength λ: 1064 nm) at ambient atmosphere, ambient pressure and ambient temperature.

The other process parameters were:

Pₚ (peak pulse power of the outgoing laser radiation): 38 kW
Pₘ (average power of the outgoing laser radiation): 6 W
t (pulse length of the laser pulses): 17 ns
f (repetition rate of the laser pulses) 10 kHz
v (scanning speed on the workpiece surface): 800 mm/s
d (diameter of the laser beam on the workpiece): 80 μm
α (absorption of the laser radiation of the irradiated material): 15%
Tᵥ (boiling point of the material at normal pressure): 3560 K
cₚ (specific thermal capacity): 580 J/kgK
κ (specific thermal conductivity) 22 W/mK

This results in ε=1.2, i.e. ε is within the range according to the invention.

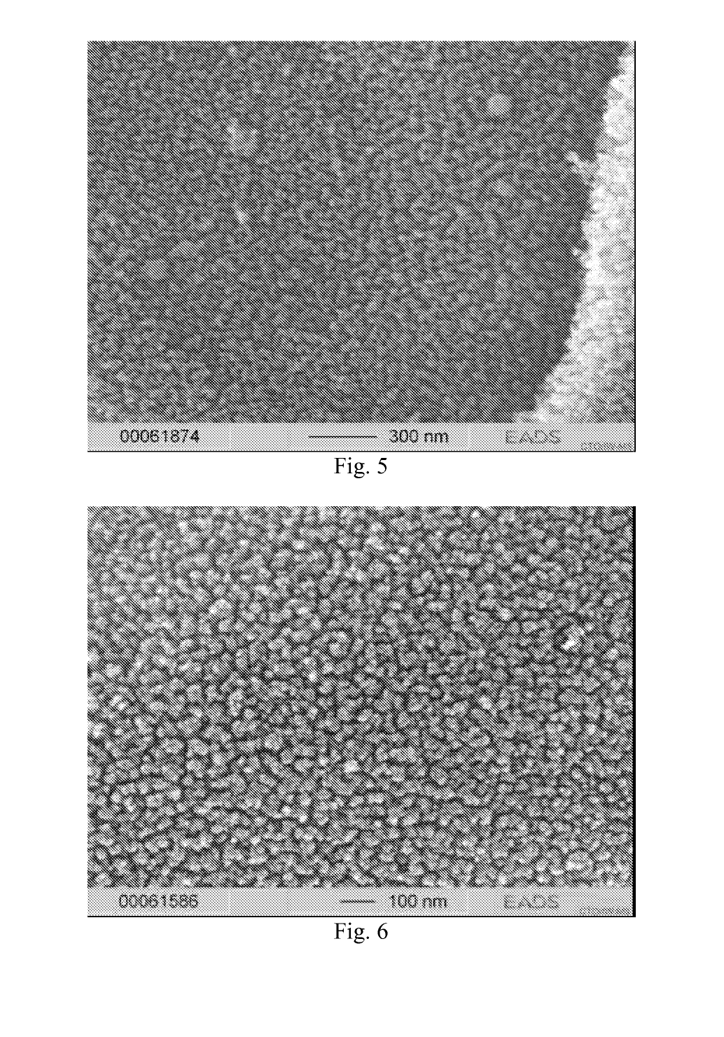

The surface structure produced is shown in the SEM image in FIG. 3.

### Example 2

A rolled metal sheet made of the alloy Mg-3Al-1Zn was scanned without any pre-treatment once with a diode-pumped Nd:YAG laser of wavelength λ: 266 nm at ambient atmosphere, ambient pressure and ambient temperature.

The other process parameters were:

Pₚ: 16 kW; Pₘ: 88 W; t: 140 ns; f: 40 kHz; v: 200 mm/s; d: 45 μm; α: 85%;
T_{V}: 1375 K; cₚ: 1023 J/kgK; κ: 170 W/mK.

This results in ε=2274, i.e. ε is within the range according to the invention.

The surface structure produced is shown in the SEM image in FIG. 4.

### Example 3

A rolled metal sheet made of the alloy Ta-10W was scanned without any pre-treatment once with a diode-pumped Nd:YVO₄ (neodymium-pumped yttrium orthovanadate) laser (wavelength λ: 1064 nm) at ambient atmosphere, ambient pressure and ambient temperature.

The other process parameters were:

Pₚ: 86 kW; Pₘ: 11.5 W; t: 13 ns; f: 10 kHz; v: 800 mm/s; d: 80 μm; α: 30%;
T_{V}: 3773 K; cₚ: 140 J/kgK; κ: 57 W/mK

This results in ε=19.3, i.e. ε is within the range according to the invention.

The surface structure produced is shown in the SEM image in FIG. 5.

### Example 4

A rolled copper sheet was scanned without any pre-treatment once with a diode-pumped Nd:YVO₄ (neodymium-pumped yttrium orthovanadate) laser (wavelength λ: 1064 nm) at ambient atmosphere, ambient pressure and ambient temperature.

The other process parameters were:

Pₚ: 16 kW; Pₘ: 24.5 W; t: 30 ns; f: 50 kHz; v: 800 mm/s; d: 80 μm; α: 3%;
T_{V}: 2609 K; cₚ: 285 J/kgK; κ: 370 W/mK

This results in ε=3.4, i.e. ε is within the range according to the invention.

The surface structure produced is shown in the SEM image in FIG. 6.

### Example 5

A rolled metal sheet made of the alloy Al2024 (Al-4.4Cu-1.5Mg-0.6Mn) was scanned without any pre-treatment once with a diode-pumped Nd:YAG (neodymium-pumped yttrium aluminum garnet) laser (wavelength λ: 533 nm) at ambient atmosphere, ambient pressure and ambient temperature.

The other process parameters were:

Pₚ: 68 kW; Pₘ: 77 W; t: 57 ns; f: 20 kHz; v: 100 mm/s; d: 80 μm; α: 45%;
T_{V}: 2543 K; cₚ: 897 J/kgK; κ: 80 W/mK

This results in ε=1873, i.e. ε is within the range according to the invention.

The surface structure produced is shown in the SEM image in FIG. 7.

### Example 6

A rolled metal sheet made of V2A (1.4301) steel (X5CrNi18-10) was scanned without any pre-treatment once with a diode-pumped Nd:YAG laser (wavelength λ: 266 nm at ambient atmosphere, ambient pressure and ambient temperature.

The other process parameters were:

Pₚ: 30 kW; Pₘ: 198 W; t: 66 ns; f: 100 kHz; v: 1200 mm/s; d: 160 μm; α: 90%;
T_{V}: 3173 K; cₚ: 450 J/kgK; κ: 80 W/mK

This results in ε=479, i.e. ε is within the range according to the invention.

The surface structure produced is shown in the SEM image in FIG. 8.

### Example 7

A rolled metal sheet made of the alloy Ti-6Al-4V was scanned without any pre-treatment once with a diode-pumped Nd:YVO₄ (neodymium-pumped yttrium orthovanadate) laser (wavelength λ: 1064 nm at ambient atmosphere, ambient pressure and ambient temperature.

The other process parameters were:

Pₚ: 115 kW; Pₘ: 14 W; t: 17 ns; f: 12.5 kHz; v: 800 mm/s; d: 125 μm; α: 15%;
T_{V}: 3560 K; cₚ: 580 J/kgK; κ: 22 W/mK

This results in ε=5.9, i.e. ε is within the range according to the invention.

The specimen produced in this way was designated as Ti-1.

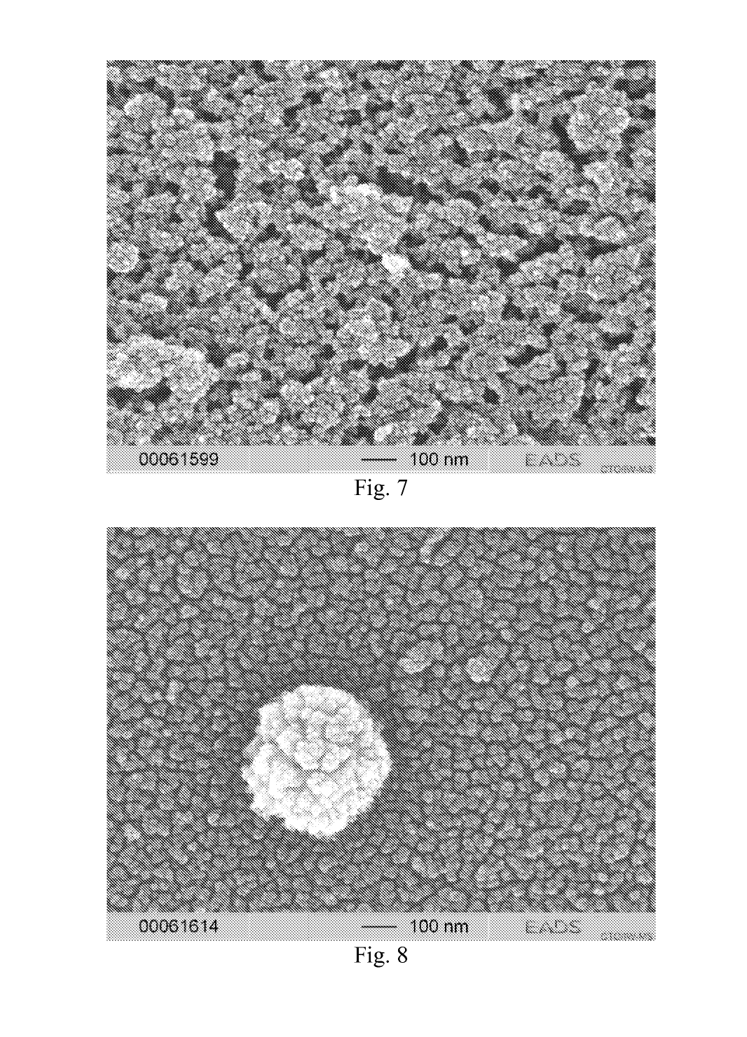

The surface structure produced is shown in FIG. 9, wherein in the upper two illustrations a plan view of the scanned surface is shown in two SEM images at resolutions, whereas the lower two illustrations show SEM images of break edges at different resolutions.

### Example 8

A rolled metal sheet made of the alloy Ti-6Al-4V was scanned without any pre-treatment once with a diode-pumped Nd:YVO₄ (neodymium-pumped yttrium orthovanadate) laser (wavelength λ: 1064 nm at ambient atmosphere, ambient pressure and ambient temperature.

The other process parameters were:

Pₚ: 70 kW; Pₘ: 10 W; t: 14 ns; f: 10 kHz; v: 800 mm/s; d: 125 μm; α: 15%;
T_{V}: 3560 K; cₚ: 580 J/kgK; κ: 22 W/mK

This results in ε=1.9, i.e. ε is within the range according to the invention.

The specimen produced in this way was designated as Ti-2.

The surface structure produced is shown in FIG. 10, wherein in the upper two illustrations a plan view of the scanned surface is shown in two SEM images at resolutions, whereas the lower two illustrations show SEM images of break edges at different resolutions.

### Example 9

A rolled metal sheet made of the alloy Ti-6Al-4V was scanned without any pre-treatment once with a diode-pumped Nd:YVO₄ (neodymium-pumped yttrium orthovanadate) laser (wavelength λ: 1064 nm at ambient atmosphere, ambient pressure and ambient temperature.

The other process parameters were:

Pₚ: 9.5 kW; Pₘ: 25 W; t: 35 ns; f: 80 kHz; v: 800 mm/s; d: 125 μm; α: 15%;
T_{V}: 3560 K; cₚ: 580 J/kgK; κ: 22 W/mK

This results in ε=0.3, i.e. ε is within the range according to the invention.

The specimen produced in this way was designated as Ti-5.

The surface structure produced is shown in FIG. 11, wherein in the upper two illustrations a plan view of the scanned surface is shown in two SEM images at resolutions, whereas the lower two illustrations show SEM images of break edges at different resolutions.

### Comparative Example 1

A rolled metal sheet made of the alloy Ti-6Al-4V was scanned without any pre-treatment once with a diode-pumped Nd:YVO₄ (neodymium-pumped yttrium orthovanadate) laser (wavelength λ: 1064 nm at ambient atmosphere, ambient pressure and ambient temperature.

The other process parameters were:

Pₚ: 0.7 kW; Pₘ: 10 W; t: 70 ns; f: 200 kHz; v: 800 mm/s; d: 80 μm; α: 15%;
T_{V}: 3560 K; cₚ: 580 J/kgK; κ: 22 W/mK

This results in ε=0.02, i.e. ε is within the range according to the invention.

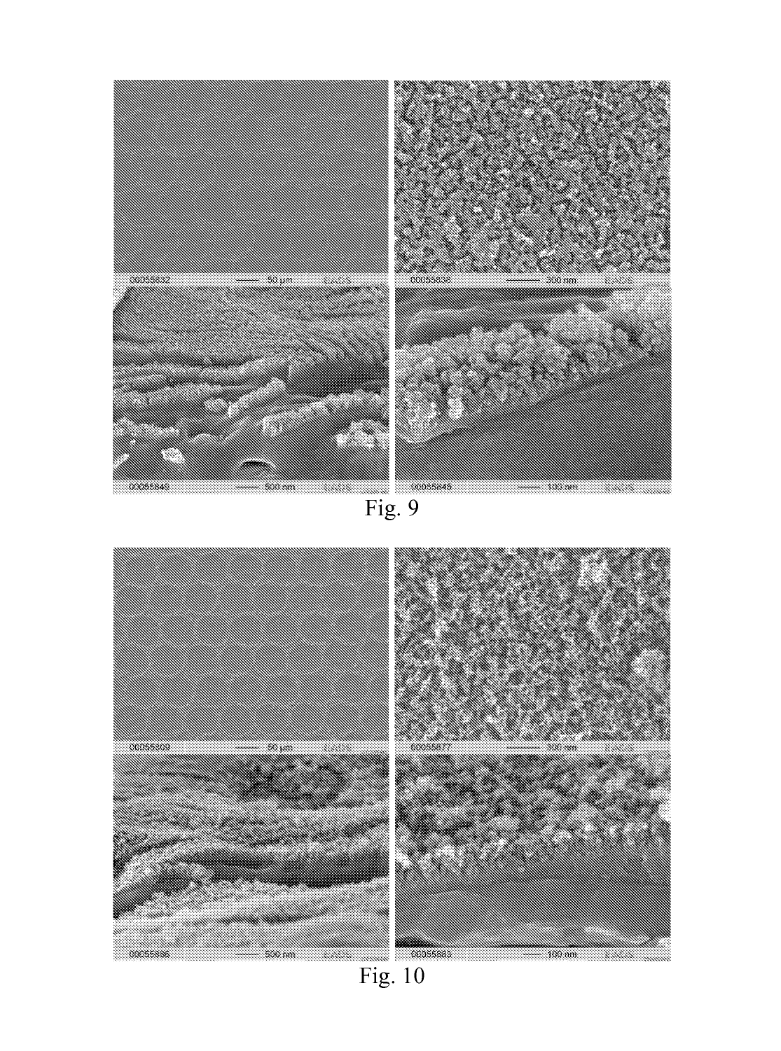

The unstructured surface thus obtained is shown in FIG. 12.

### Example 10

### Wedge Test (DIN 65448)

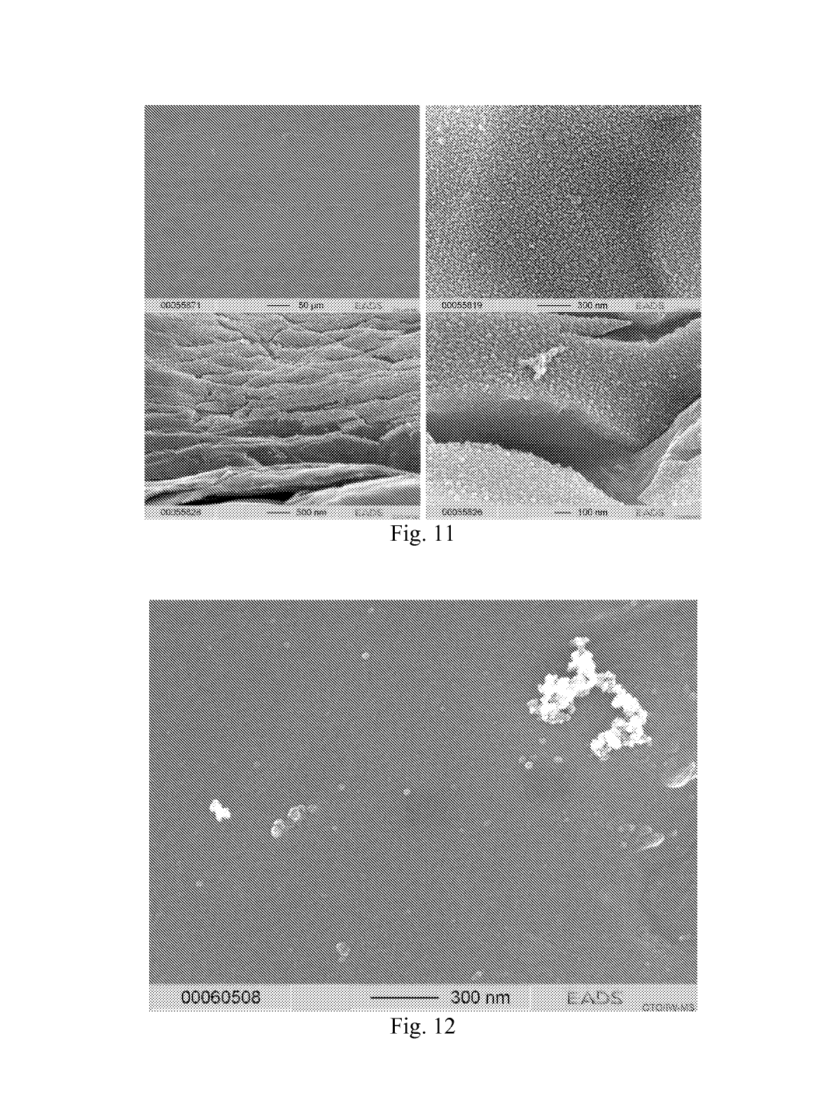

In the wedge test a wedge is driven between two adhered metal sheets, resulting in deformation of the metal sheets and tearing of the adhesive layer. The strain energy stored by the distortion in the joining parts is reduced by the crack progression in the adhesive layer until a balance is established. Due to the ageing of the adhesive connection the crack propagation continues. For evaluation, the initial crack tip and at specific time intervals the crack tips after exposure in a hot moist climate (for example approximately 50° C. and approximately 95% relative humidity) are marked. The test is very suitable for comparing different pre-treatment methods with respect to their crack propagation rate. The method is illustrated schematically in FIG. 13 (the illustration has been taken from Habenicht G., Kleben Grundlagen-Technologie-Anwendungen, 6. Auflage Springer-Verlag Berlin Heidelberg New York (2009)).

In each case two samples of the preceding Examples 6 to 8 (Ti1, Ti2 and Ti5) have been adhered on the nanostructured side by a bonding adhesive (FM 73M, Cytec Engineering Materials Inc. USA) with a layer thickness of 0.2 to 0.3 mm. The bonding adhesive was cured for 90 minutes at a pressure of 2.5 bars in an autoclave.

As a comparison two samples in each case were (a) etched alkalinically with the NaOH-based commercial etching product Turco 5578 (Henkel) (sample “Turco 5578”) or (b) treated by the NaTESi method. The NaTESi method is an anodizing process, such as is described for example in DE 34 27 543 A1), which can be used on titanium materials. The bath consists of an alkali hydroxide, a titanium complexing agent and a foreign ion complexing agent. The samples were adhered with FM 73 after the pre-treatment with “Turco 5578” or the “NaTESi method” as described above.

Then a plurality of samples in each case of Ti1, Ti2, Ti5, Turco 5578 and NaTESi were subjected to the wedge test described above and stored for 1000 hours in the hot moist climate.

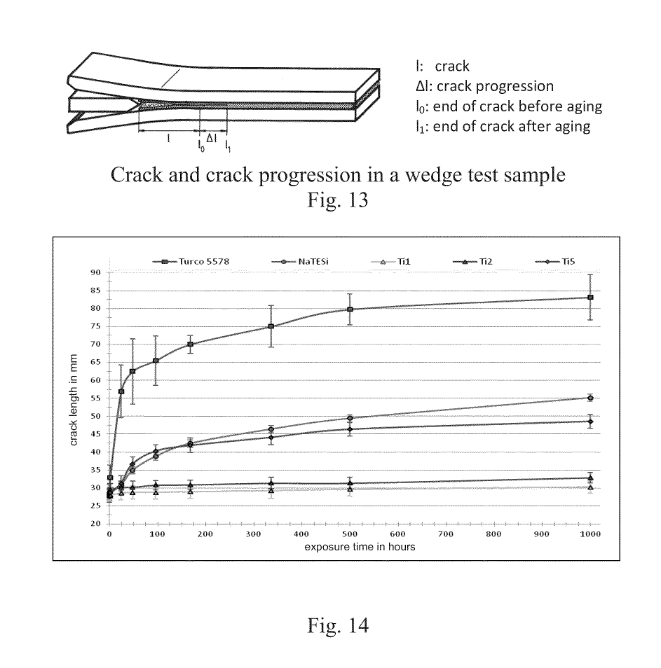

FIG. 14 shows the crack progression of the laser-treated Ti1, Ti2 and Ti5 samples as well as the two comparative samples over a storage time of 1000 hours.

The Ti1 and Ti2 samples achieved very good results. In the Ti1 samples the crack expanded from 27.8±1.6 to 30.2±1.7 mm over the entire exposure time. In the Ti2 samples the crack progression is similarly small with an initial crack length of 29.4±1.4 mm and a final value of 32.9±1.5 mm. By comparison with the NaTESi reference method both the initial crack rate and also the crack length after the end of the exposure time are significantly smaller.

However the Ti5 samples with a crack length of 48.6±1.9 mm achieved better results after a trial duration of 1000 hours than the NaTESi method (55.1±2.5 mm). Only at the start of the test the crack rate is somewhat higher than in the NaTESi method.

The low standard deviation of the laser-treated samples Ti1, Ti2 and Ti5, which reflects constant and readily reproducible results, is also striking

Accordingly the surface nanomorphology ensures a very good bonding adhesion. The Ti1 and Ti2 samples have an open-pored structure with deep troughs. Due to such a structure of the surface the bonding adhesive can penetrate into the pores, so that a mechanical anchoring of the bonding adhesive in the substrate is made possible. The Ti5 samples show a roughened, knobbly surface, so that likewise the effective adhesive surface area is increased and a mechanical anchoring is made possible.

### Example 11

### Production of an (Ultra)Hydrophobic Surface with Icing Preventing Behavior

A rolled metal sheet made of the alloy Al2024 (Al-4.4Cu-1.5Mg-0.6Mn) was scanned without any further pre-treatment once with a diode-pumped Nd:YVO₄ (neodymium-pumped yttrium orthovanadate) laser (wavelength λ: 1064 nm at ambient atmosphere, ambient pressure and ambient temperature.

The other process parameters were:

Pₚ: 38 kW; Pₘ: 6 W; t: 17 ns; f: 10 kHz; v: 800 mm/s; d: 80 μm; α: 5%; Tᵥ: 2543 K; cₚ: 897 J/kgK; κ: 80 W/mK.

This results in ε=1.24, i.e. ε is within the range according to the invention.

After the laser treatment the sample was cleaned with isopropanol and dried with nitrogen. In order to give the sample (super) hydrophobic characteristics, the laser-structured surface must also be provided (functionalised) with a chemical anti-adhesion coating. This can take place for example by bonding of fluorinated hydrocarbons, fluorosilanes, long-chain hydrocarbons or oils.

In the present example the samples have been treated with a fluorosilane (Dynasylan F 8261 from Degussa). For this purpose the silane is hydrolyzed for 2 hours in a water/hydrochloric acid/isopropanol mixture. In this case the following composition was used: 2% by weight F8261, 5% by weight H₂O and 0.2% by weight HCl (37%) and the rest isopropanol. The samples were immersed in the solution for 10 minutes and then rinsed with completely desalinated water. Then the samples were exposed at 80° C. for 1 hour in the oven.

The contact angle of the produced samples with water was 140°. With such a contact angle the adhesion of ice to the surface is considerably reduced.

Depending upon the composition of the chemical coating or functionalisation agent a contact angle with water of approximately 100° to approximately 150° can be set (surfaces with a contact angle≧150° are designated as ultrahydrophobic or superhydrophobic). By comparison with a sample of the alloy Al2024 in the initial state, which had only been cleaned with solvent or etched acidically or alkalinically, an increase in the contact angle with water of approximately 50° to approximately 100° is achieved. If an etched and chemically hydrophobised surface is compared with a laser-structured and chemically hydrophobised surface, it is apparent that the hydrophobicity can be significantly increased for example from a contact angle of 120° in the former to a contact angle of 150° in the latter.

All documents cited here, such as patents, patent applications, journal articles and standards, are hereby incorporated by reference into this patent application. The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-16. (canceled)

17. A method for structuring a surface of a workpiece, comprising a metal or a metal alloy or a metal oxide layer or metal alloy oxide layer present on a metal or metal alloy surface, the method comprising:
producing surface structures with dimensions in the sub-micrometer range on the workpiece by scanning, one or more times by a pulsed laser beam, an entire surface of the metal or of the metal alloy, or the metal or metal alloy oxide layer on the metal or the metal alloy that are accessible to laser radiation, wherein the scanning is performed in such a way that adjacent flecks of light of the laser beam adjoin one another without gaps or overlap one another, wherein the following conditions are met
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: peak pulse power of the outgoing laser radiation [kW]
Pₘ: average power of the outgoing laser beam [W]
t: pulse length of the laser pulses [ns], wherein t is approximately 0.1 ns to approximately 2000 ns,
f: repetition rate of the laser pulses [kHz]
v: scanning speed on the workpiece surface [mm/s]
d: diameter of the laser beam on the workpiece [μm]
α: absorption of the laser radiation of the irradiated material [%] under normal conditions
λ: wavelength of the laser radiation [nm], wherein λ=approximately 100 nm to approximately 11000 nm
T_{V}: boiling point of the material [K] at normal pressure
cₚ: specific thermal capacity [J/kgK] under normal conditions
κ: specific thermal conductivity [W/mK] under normal conditions
wherein an atmosphere in which the method is carried out is a vacuum, ambient atmosphere or an inert gas or gas mixture.

18. The method of claim 17, wherein a pressure of the atmosphere is in the range from approximately 0 bars to approximately 15 bars and a temperature of the atmosphere outside of the laser beam is in the range from approximately −50° C. to approximately 350° C.

19. The method of claim 17, wherein approximately 0.07≦ε≦approximately 2000, more preferably approximately 0.07≦ε≦approximately 1500.

20. The method of claim 17, wherein the pulse length of the laser pulses t is approximately 0.1 ns to approximately 300 ns.

21. The method of claim 17, wherein the pulse length of the laser pulses t is approximately 5 ns to approximately 200 ns.

22. The method of claim 17, wherein the metal surface is not pre-treated or cleaned before the irradiation with the laser beam.

23. The method of claim 17, wherein the metal or the metal alloy is selected from iron, aluminum, magnesium, tantalum, copper, nickel or titanium or an alloy thereof.

24. The method of claim 17, wherein the peak pulse power of the outgoing laser radiation Pₚ is approximately 1 kW to approximately 1800 kW.

25. The method of claim 17, wherein the average power of the outgoing laser radiation Pₘ is approximately 5 W to approximately 28000 W.

26. The method of claim 17, wherein the repetition rate of the laser pulses f is approximately 10 kHz to approximately 3000 kHz.

27. The method of claim 17, wherein the scanning speed on the workpiece surface v is approximately 30 mm/s to approximately 19000 mm/s.

28. The method of claim 17, wherein the diameter of the laser beam on the workpiece d is approximately 20 μm to approximately 4500 μm.

29. The method of claim 17, wherein after the structuring of the surface the surface is joined or without bonding adhesive to a surface of a second workpiece to form a composite workpiece joined together or is provided with a coating or is chemically modified.

30. A workpiece comprising:
a surface of a metal or a metal alloy or a metal oxide layer or metal alloy oxide layer on the surface of the metal or the metal alloy, wherein the surface has a structure produced by
scanning, one or more times by a pulsed laser beam, an entire surface of the metal or of the metal alloy, or the metal or metal alloy oxide layer on the metal or the metal alloy that are accessible to laser radiation, wherein the scanning is performed in such a way that adjacent flecks of light of the laser beam adjoin one another without gaps or overlap one another, wherein the following conditions are met
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: peak pulse power of the outgoing laser radiation [kW]
Pₘ: average power of the outgoing laser beam [W]
t: pulse length of the laser pulses [ns], wherein t is approximately 0.1 ns to approximately 2000 ns,
f: repetition rate of the laser pulses [kHz]
v: scanning speed on the workpiece surface [mm/s]
d: diameter of the laser beam on the workpiece [μm]
α: absorption of the laser radiation of the irradiated material [%] under normal conditions
λ: wavelength of the laser radiation [nm], wherein λ=approximately 100 nm to approximately 11000 nm
T_{V}: boiling point of the material [K] at normal pressure
cₚ: specific thermal capacity [J/kgK] under normal conditions
κ: specific thermal conductivity [W/mK] under normal conditions
wherein an atmosphere in which the method is carried out is a vacuum, ambient atmosphere or an inert gas or gas mixture.

31. A workpiece of claim 30, wherein the surface has open-pored, split or fractal-like peak and trough, undercut or bulbous structures, of which the dimensions with the exception of the trough lengths of the peak and trough structure are under 1 μm.

32. The workpiece of claim 30, wherein the surface is passivated by a metal or metal alloy oxide layer.

33. A workpiece or composite workpiece, which is produced by:
producing surface structures with dimensions in the sub-micrometer range on the workpiece by scanning, one or more times by a pulsed laser beam, an entire surface of the metal or of the metal alloy, or the metal or metal alloy oxide layer on the metal or the metal alloy that are accessible to laser radiation, wherein the scanning is performed in such a way that adjacent flecks of light of the laser beam adjoin one another without gaps or overlap one another, wherein the following conditions are met
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: peak pulse power of the outgoing laser radiation [kW]
Pₘ: average power of the outgoing laser beam [W]
t: pulse length of the laser pulses [ns], wherein t is approximately 0.1 ns to approximately 2000 ns,
f: repetition rate of the laser pulses [kHz]
v: scanning speed on the workpiece surface [mm/s]
d: diameter of the laser beam on the workpiece [μm]
α: absorption of the laser radiation of the irradiated material [%] under normal conditions
λ: wavelength of the laser radiation [nm], wherein λ=approximately 100 nm to approximately 11000 nm
T_{V}: boiling point of the material [K] at normal pressure
cₚ: specific thermal capacity [J/kgK] under normal conditions
κ: specific thermal conductivity [W/mK] under normal conditions
wherein an atmosphere in which the method is carried out is a vacuum, ambient atmosphere or an inert gas or gas mixture,
wherein after the structuring of the surface the surface is joined or without bonding adhesive to a surface of a second workpiece to form a composite workpiece joined together or is provided with a coating or is chemically modified.
